(19) United States
(12) Patent Application Publication
(10) Pub. No.: US 2004/0179787 A1
(43) Pub. Date: Sep. 16, 2004

(54) Dual shutter fiber optic connector

(76) Inventors: Edward Glazowski, Mahwah, NJ (US); David Wostbrock, Middland Park, NJ (US)

Correspondence Address: MORGAN & FINNEGAN, L.L.P., 345 Park Avenue, New York, NY, 10154-0053, US

(21) Appl. No.: 10/798,801

(22) Filed: Mar. 10, 2004

Related U.S. Application Data
(60) Provisional application No. 60/453,373, filed on Mar. 10, 2003.

(51) Int. Cl. G02B 6/36

(52) U.S. Cl. 385/76

(57) ABSTRACT

A dual shutter fiber optic assembly terminating multiple optical fibers at a connection point, comprising a fiber optic connector and a receptacle with a shutter situated on each side of the termination, is described. The shutters are operatively connected to the receptacle and connector, so as to move between a first and second position. In the first position, when the connector and receptacle are not joined, the shutters cover a connection aperture on both the connector and the receptacle, respectively. When the connector is joined with the receptacle, the shutters move into the second position, thereby uncovering the connection apertures. Additionally, the receptacle may include a spring-loaded Micro-switch actuated by inserting or withdrawing the connector from the receptacle. The Micro-switch is operatively connected to a power source for the light emitting device terminated by the receptacle.

### RELATED APPLICATION

The instant application, hereby incorporates by reference and claims priority to the Provisional Patent Application, Serial No. 60/453,373, entitled “Dual Shutter Optical Fiber Connector, filed on Mar. 10, 2003.

### FIELD OF THE INVENTION

The invention relates to an improved connector that enhances safety and reliability of fiber optic cable connections. More specifically, the invention relates to a connection that incorporates a shutter mechanism operatively situated on each side of a fiber optic connector to cover and to protect the terminal faces of the mating connection elements when they are in a disconnected state and to uncover such faces when the elements are connected.

### BACKGROUND OF THE INVENTION

Fiber optic cables carry information signals over a light-transmitting core through which modulated light travels. The light signal may, for example, originate from a laser, LED or VCSEL (vertical cavity surface emitting laser diode) device. The fiber optic path between a light modulating source and a receiver at which the signals may be recovered by demodulating the received light signal may include several segments defined by connections between cable runs. Alternately, the fiber optic paths may include connections between fiber optic cable and electronic components such as a laser source, modulators, repeater amplifiers or other components of a fiber optic network. Not infrequently, it is necessary to disconnect a cable segment or run from another segment or one of the electronic components. Upon disconnection, one side of the connection may remain coupled to a light source, in which case someone may be exposed inadvertently to intense and potentially sight-damaging light emanating from a disconnected termination.

Moreover, an unprotected connection point can allow the terminal ends of the optical fiber to be physically damaged or contaminated with substances that impair the quality of optical coupling once the connectors are joined. It is desirable, therefore, to protect against potentially harmful injury from and to guard against damage to fiber optic cable receptacle and connector components during periods of disconnection.

One prior art technique that addresses this concern utilizes a shutter on the receptacle side of a fiber optic cable termination that closes over the end of the fixed receptacle when the fiber optic cable is disconnected from the receptacle. When the connector is joined with the receptacle, the shutter is positioned so as to expose the fiber optic terminations within the receptacle; the shutter transitions to a closed state when the connector is removed. This achieves protection on the receptacle side of the termination when the connector is not connected. However, the other side of the termination, which often presents the greatest of risk of damage and hazards, remains unprotected and exposed to dust and other environmental hazards. Further, the user is much more likely to be exposed to harmful emissions from the flexible fiber optic cable, such as intensely bright laser light.

Another prior art technique, described in U.S. Pat. No. 6,511,229, employs a connector shutter mechanism on each of mating connectors. The fiber optic interface on each connector is covered by a portion of a thin shutter piece that deforms to move in a sideways direction, i.e., transversely relative to the connection axis, when the connectors are joined. A so-called actuator situated on the opposite sides of the connection engages the deformable shutter element to move the covering portion into the “open” position, thereby exposing the terminal interface. The shutter motion includes a rotational component that allows the shutter to also lift. The approach of this patent, however, requires that the transverse dimension be sufficiently large to accommodate a support for the deformable shutter piece or to accommodate the sideways displacement of the shutter. As a result, the connections are increased in dimension and bulk. Additionally, the shutter material is thin and may be subject to fatigue with repeated connection/disconnection cycles. Moreover, only limited lateral movement of the shutter is possible if the dimensions of the connector bodies are kept to a minimum, in which case it may be impractical to protect larger interface areas using that technique.

### SUMMARY OF THE INVENTION

The invention remedies the foregoing problems, inter alia, by providing two shutters at the connection point, one situated on the connector side and the other situated on the receptacle side of a fiber optic cable termination assembly. The shutters operate to close over the ends of the terminations at each side of the connection and thereby block light emissions from both sides of the disconnected termination assembly. Also, the components of both the connector and the receptacle over the entire interfacing areas are protected from environmental hazards. The shutters are preferably rotatably supported on the connector and receptacle bodies and include a cam element that engages an opposing surface on the other side of the connection as the connector and receptacle are joined. Upon engaging the connector unit with the receptacle unit, both shutters are cammed or otherwise moved into an open position, allowing fiber optic ferrules in the connector unit and the receptacle unit to establish an optical path across the connection.

### BRIEF DESCRIPTION OF THE DRAWINGS

A more complete understanding of the invention, together with the various features and advantages thereof, will be gained from the following detailed description, taken in conjunction with the drawings, in which:

FIG. 1 is a perspective view of a fiber optic cable connector accordingly to the invention illustrating the open and closed positions of a fiber optic connector shutter.

FIG. 2 is a perspective view of a fiber optic cable receptacle bulkhead illustrating the open and closed positions of a fiber optic receptacle shutter.

FIG. 3A is a top perspective view of a fiber optic cable termination assembly according to the invention, illustrating a joined connector unit and receptacle unit.

FIG. 3B is a bottom perspective view of the fiber optic cable termination assembly of FIG. 3A.

FIG. 4A is a perspective view of a fiber optic connector shutter adapted for use with the connector cover of FIG. 1.

FIG. 4B is a perspective view of a fiber optic receptacle shutter adapted for use in the jack bulkhead of FIG. 2.

FIG. 5A is a side view of the fiber optic cable termination assembly of FIGS. 3A-3B illustrating the joined connector unit and receptacle unit.

FIG. 5B is a cross-sectional view of the fiber optic cable termination assembly, taken along line B-B in FIG. 3A.

FIG. 6A is a top view of the fiber optic cable termination assembly of FIGS. 3A-3B illustrating the joined connector unit and receptacle unit.

FIG. 6B is a cross-sectional view of the fiber optic cable termination assembly taken along the line B-B in FIG. 6A.

FIG. 7 is a perspective view of the fiber optic connector cover.

FIG. 8 is a perspective view of the fiber optic connector base.

FIG. 9A is a perspective view of a fiber optic receptacle jack base.

FIG. 9B is a side view of the fiber optic receptacle jack base.

FIG. 9C is a cross-sectional view of the jack base body.

FIG. 9D is a front view of the jack base body.

FIG. 10 is a perspective view of a fiber optic receptacle jack base cover.

### DETAILED DESCRIPTION OF THE PREFERRED EMBODIMENTS

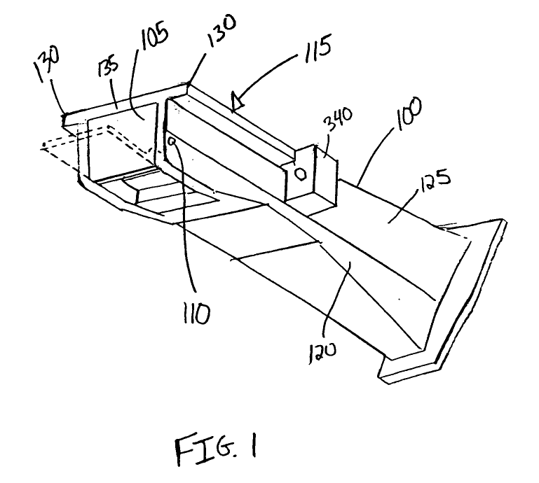

FIG. 1 depicts a representative multiple fiber optic connector 100 according to the invention, with a protective shutter 105 on the forward end 115 of the connector 100. As is well known in the art, multiple fiber connectors are used to terminate multiple optical fibers at a connection point. The fibers are terminated with ferrules which support the fiber ends in the connection. In FIG. 1, these ferrules (not shown) are located in the body of the connector behind the shutter 105, which is shown in the closed position. The connector body is comprised of a base 125 (FIG. 8) and cover 120 (FIG. 7), which is removable so that access can be gained into the interior of the connector body. As will be apparent from the ensuing description, the ferrules are customarily arranged in one or more rows. Multiple fiber cables can have from 1 to 6 individual ferrules, each ferrule containing from 1 to 72 fibers.

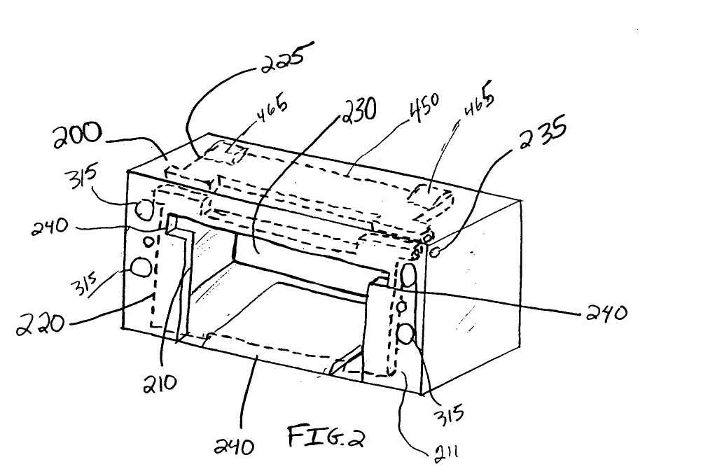

In FIG. 1, the shutter 105 blocks the light emitting fibers within the connector 100 when the connector 100 is disconnected from a fiber optic receptacle 300 (shown in FIGS. 3A and 3B). When the connector 100 is joined to its receptacle 300, the shutter 105 is cammed into an open position, indicated by the phantom lines. The shutter 105 rotates about connector pivot point 110 when the connector 100 is inserted into the receptacle 300, thereby uncovering connector face and exposing the light emitting at the ferrules carried within the connector 100. It will be understood that the exposed ferrules align with similarly arranged ferrules within the receptacle 300 on the other side of the connection.

The receptacle 300 for the connector 100 is preferably comprised of two mating components: (i) a bulkhead 200 which receives the forward end 115 of the connector 100 stabilizing and protecting it and (ii) a jack base 305 (seen in FIGS. 3A and 3B), which houses fiber terminating ferrules that align individually with the corresponding ferrules in the connector 100. Thus, when the connector 100 mates to the receptacle 300, the optical circuits are completed so that the light signals are carried across the connection. It should be noted that the receptacle as described herein is a component that normally attaches to a fixture that houses electronic components present in a fiber optic network. The term “receptacle” should be taken in a generic sense, however, to distinguish one side of the connection from the other. A receptacle need not be affixed to a stationary fixture.

Referring to FIG. 2, a representative bulkhead 200 component according to the invention is shown. It forms a box-like enclosure having a connector-receiving aperture 210 through its forward face 211. It is to be understood that the actual enclosure may take a variety of dimensions and shapes (e.g., elliptical, oval, etc.), based on factors including, but not limited to operating environments and materials used to form the housing. A protective shutter 450 covers the aperture 210 when in the closed position. The receptacle shutter is pivotally mounted within the receptacle bulkhead 200 and is movable between the normally closed position (indicated by phantom lines 220), and an open position (indicated by phantom lines 225.)

The receptacle bulkhead forms a protective enclosure around the top, bottom, and sides of the connection between the connector 100 and the jack base 305 at the rear of the bulkhead. To that end, the rear of the bulkhead is open to form a second aperture 230 for receiving a jack base extensions 505, 505a (see FIG. 5B), which support the connection with the jack base 305. The lower extension 505a is chauffeured to guide the connector during insertion. Pivot points 235 are the points at which the receptacle shutter attaches to the receptacle bulkhead 200. Also, the bulkhead 200 includes a connector camming surface 240 formed along the interior of its bottom forward edge. The operation of the connector camming surface 240 and its interaction with the connector shutter 105 are discussed in greater detail below. The camming surface 240 could instead take the form of one or more spaced-apart camming rails, extending from front to back of the bottom wall of the receptacle bulkhead. The camming rails may have a similar cross-sectional contour to the surface 240. While the camming surface shown in FIG. 2 is curved, it should be understood that such surface, although preferably curved, may take other forms bearing in mind that its function is to engage and move the advancing shutter of the connector as the two sides of the connector are joined.

FIGS. 3A and 3B show the connector 100 joined with receptacle 300 in their assembled state. The forward end 115 (FIG. 1) of the connector 100 joins with the receptacle 300 to provide a fiber optic interface between two terminating ends of an optical fiber path. It will be understood that a multiple fiber optic cable (not shown) is terminated by the connector 100, whereas the other side of the connection is terminated by the jack base 305, which contains terminating ferrules for a similar multiple fiber optic cable. As illustrated, an elongated aperture 355 at the rear end of connector receives a flat, or ribbon-type, fiber optic cable to which terminating fiber optic ferrules have been applied. This aperture 355 may have other configurations, as well. For example, some fiber optic cables may be round in cross-section and the aperture can be configured to conform to the cable cross-section. Similarly, the contour of the exterior of the receptacle may also be modified in accordance with different operating environments.

The connector body laterally widens toward the forward end 115, so that the individual ferrules can be spread, thereby allowing the ferrules to assume a lineal alignment at the forward end 115 of the connector. Additionally, the height of the connector is reduced as the lateral width is increased so that the individual fiber ferrules are held within individual ferrule guide channels 512, while diminishing the height of the connection.. Two tabs 340 that extend laterally from the sides of the connector cover 120 contain holes 345 for retaining screws that engage threaded holes 365 in the receptacle.

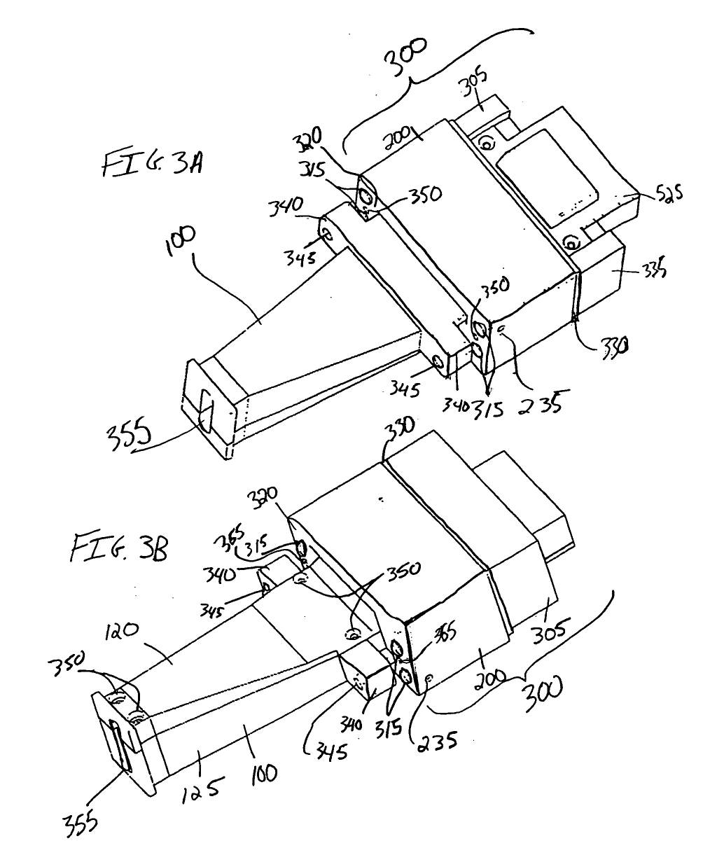

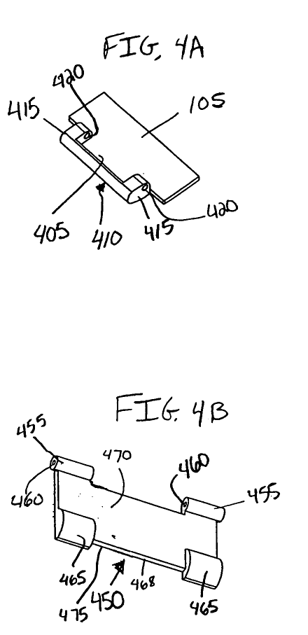

FIGS. 4A and 4B illustrate the respective shutters for on the connector 100 and receptacle bulkhead 200. Referring to FIG. 4A, the connector shutter 105 is a unitary member formed with an essentially flat cover plate having a section 405 of narrower transverse dimension at its pivot, or hinged, edge. The section 405 has a curved surface 410 that extends beyond the inner edge (in FIG. 1) of the connector body, and faces the receptacle when the shutter is mounted on the connector body in its closed position. As illustrated, the inner face of the connector shutter 105 is essentially flat. This face, however, need not be flat as, for example, in cases where a ridge traces the periphery of the shutter to better register the shutter when in the closed position, or to create a seal at the forward face of the connector body. The section 405 acts as a cam and is urged by a connector camming surface 240 situated on the receptacle bulkhead 200. The interaction between the cam surface 410 and the bulkhead camming surface 240 is described in greater detail below. Shutter mounting supports 415 are provided at the corners of the shutter section 405, and like those on the receptacle shutter (shown in FIG. 4B), have small bores 420 for accepting a pivot pin, screw or the like (not shown). Such pivot elements define the shutter's rotational axis, extending through the connector cover 120 into the shutter supports mounting. Also, torsion springs (not shown) situated, for example, about the pivot element bias the connector shutter 105 in the closed position when the connector 100 is not connected with receptacle 300.

FIG. 4B shows the receptacle shutter 450 in greater detail. It is essentially a flat member 470 having two mounting supports 455 at its top edge. These supports have small bores 460 for accepting a pivot pin, screw or the like (not shown) that extends through the side walls of the bulkhead 200 so that the shutter 450 is pivotally supported immediately behind the forward face 211 of the receptacle bulkhead 200. Torsion springs (not shown) situated at the receptacle bulkhead pivot points 235 bias the connector shutter 100 in the closed position (in a manner similar to the connector shutter) when the connector and receptacle are separated.

Semi-cylindrical stops 465 extend slightly below the lower edge 468 of the shutter 450 on the interior face 470 and serve to prevent the receptacle shutter 450 from over-rotating in the open position. It will be seen that lower edge 468 of the shutter conforms to the geometry at the lower edge of the bulkhead aperture 210 so as to completely cover the aperture opening when the shutter 450 is in its closed position. Alternately, the stops 465 may be formed in different configurations based on various operating environments. For example, a stop need not project beyond lower edge 468 and can be laterally dimensioned to extend over a greater width of the shutter.

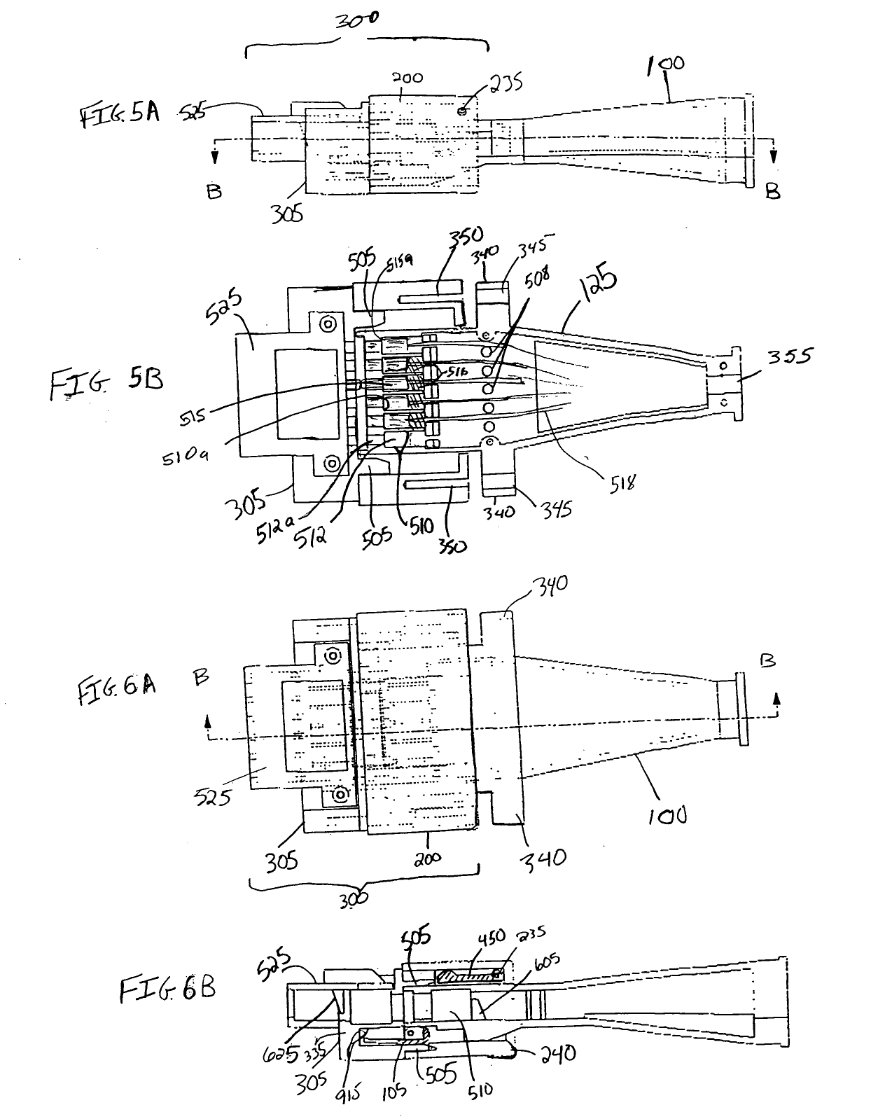

The details of the connector base 125 and its interior components can best be appreciated from the cross-sectional views of FIGS. 5B and 6B. Referring to FIG. 5B, the interior of the forward end of the connector base 125 includes a transverse row of spaced-apart fiber guide posts 508 which project upwardly from the bottom surface of the base. The fiber guide posts 508 serve to separate and locate the optical fibers for general alignment with respective ferrule guide rails 510, which define guide channels 512 having a narrower transverse dimension constituting front channels 512(a), receive and stabilize the individual fiber ferrules (not illustrated). The front channels 512a, in turn, align the connector terminations with those in the receptacle 300. As noted earlier, depending on the application, the ferrules can be physically positioned in any desired geometry, typically in two or more rows of fiber terminating ferrules. The invention is not dependent on the configuration of the ferrules per se. The ferrules may be, for example, the MT type, which incorporates a male-female combination that includes aligning guide pins, available from USCONEC of Hickory, N.C., USA.

As noted above, the channels 512 formed between rails 510 have a narrow front channel 512(a). As illustrated, the ferrules 515 are rectangular in cross section and have a relatively narrow forward section accommodated within the narrow portion of the guide channels, and a relatively wide rear section that forms a shoulder 515a. This shoulder locates the ferrules against the surfaces of the front guide channels 512a. The wider portion of the ferrule guide channels 512 accommodates the wider part of the ferrules, as well as a spring 516 attached to each ferrule (as shown) and surrounding the core of the cable 518. When the ferrules reside in their channels, the spring is compressed and exerts resilient force to hold each ferrule in place against the surfaces 510a at the points where the channels narrow, while allowing for axial movement to ensure contact with the ferrules of the receptacle. When a user inserts the connector 100 into the receptacle 300, the axes of the guide channels 512a and ferrules in the connector 100 align with the axes of ferrules and guide channels 905a in the jack base 305. Accordingly, it will be understood that when the connector and receptacle are mated the terminal ends of the ferrules at each side of the connection are axially aligned and in contact. This action also compresses the stabilization springs connected to the individual ferrules. While the guide rails and guide posts are illustrated as integrally cast with the connector body, these structures also can be separately formed from any suitable material, such as nylon, Delrin or metal.

The ferrule-terminated optical fibers are maintained in place by the structure of the cover 120, which is illustrated in FIG. 7. The exterior connector cover is dimensioned at 705 to accommodate the shutter cam section 405 of the connector shutter when the shutter is in the open position shown in phantom lines in FIG. 1. When the connector 100 and the receptacle 300 are joined, the cam section 405 is rotated into the space 705 between the rails 715 at the upper surface of the cover. The cover is formed with a row of inwardly directed projections 605 that define a rake-like wall that bears against and stabilizes the individual ferrules in their respective guide channels when the connector cover 120 is in place. In an alternate embodiment (not illustrated), support wedges are situated on a separate support spline inserted between the connector base 125 and connector cover 120, the purpose being to apply sufficient pressure and/or locating surface to resist movement of the ferrules from their desired alignment within the connector.

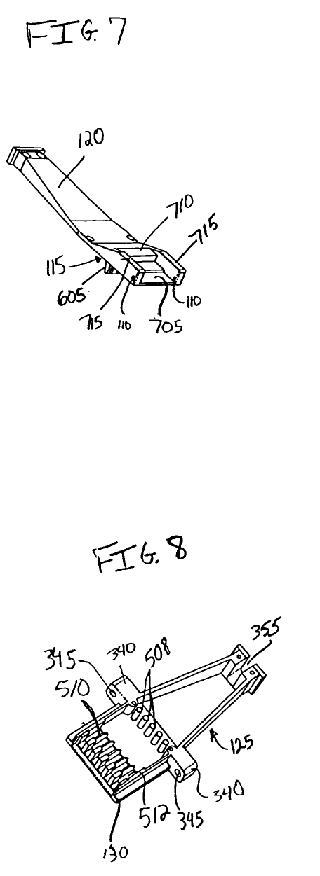

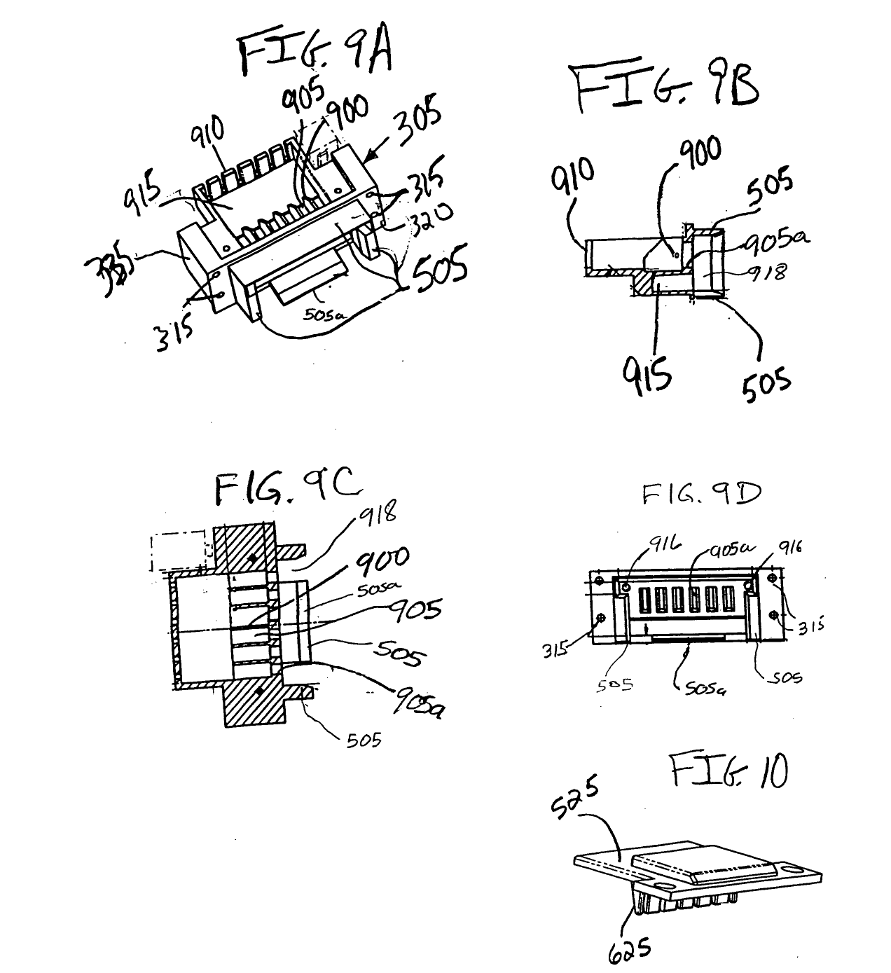

The jack base 305 comprises a jack base body 335 (FIGS. 9A-9D), and a jack base cover 525 (FIG. 10) that is secured to the body 335 by screws. The jack base 305 may, for example, be mounted on a circuit board. A user may access the individual fiber ferrules in the jack base, by removing jack base cover 525. As illustrated in FIGS. 9A-9D, the receptacle jack base 305 contains ferrule guide rails 900 and ferrule guide channels 905, 905a. The individual fibers thread through slots in the rear wall 910 of the jack base 305. The jack base ferrule guide channels 905 also have a wider rear portion and a front channel 905a that conforms to the transverse dimension of the forward ends of the compression ferrule springs. A row of rake-like projections 625, are situated on the jack base cover 525 (FIG. 10) and engage the ferrule, to stabilize both the individual ferrules and coaxial compression springs (not illustrated) in a manner similar to that described above for the ferrules in the connector. The projections 625 may be formed as a component separate from the cover 525 similar to the spline described above.

In the receptacle bulkhead 200, four fastening holes 315 in the receiving face 320 of bulkhead allow the bulkhead to be secured to the jack base 305 by screws or other fasteners. If the receptacle is mounted to a housing or other structure, as for example in FIGS. 3A and 3B, the jack base 305 is typically located in the housing interior in which case the wall 330 of the housing is located between the jack base 305 and the receptacle 200.

In operation, when initially the connector 100 and receptacle 300 are not engaged, the connector shutter 105 and the receptacle shutter 450 are in their respective closed positions (shown in FIGS. 1 and 2), blocking any laser light emanating from the ferrules on both sides. The user inserts the connector 100 into the receptacle bulkhead 200 to establish a connection. In order to ensure that the connector 100 is inserted properly into the receptacle 300, the aperture 210 has key slots 240 at its top edge. These slots 240 receive the respective flanges 130 formed along the sides of the connector base 125, so that the connector 100 can be inserted into the receptacle only in the proper orientation.

In operation, as the user inserts the connector 100 into the receptacle aperture 210, the cam engaging surface 240 of the receptacle bulkhead contacts the cam surface 410 of the connector shutter. Once the insertion force overcomes the mild resilient bias forces of the spring, the connector shutter 105, swings outwardly from its closed position to orient itself in the direction of insertion. Thus, the shutter 105 projects forwardly into the interior space within the receptacle bulkhead 200. Concurrently, during the insertion action, the forward-pivoting connector shutter 105 engages the receptacle shutter 450 and initially urges the receptacle shutter 450 inward toward its open position. As the connector continues to move into the receptacle the lower edge 135 of the connector base 125 engages the facing flat surface of the receptacle shutter 450 and continues to push the shutter inwardly until it reaches its fully open position adjacent the interior surface of the upper wall of the bulkhead. (See FIG. 2.)

The cam surface 240 in the receptacle bulkhead 200, meanwhile, also continues to cam the connector shutter 105 into its open position, until the connector 100 is fully inserted and the shutter 105 is in the full open position, thereby exposing the connector's ferrules. At this time, the fiber optic ferrules at each site of the connection are aligned to transmit light across the connection interface. While in this preferred embodiment, the connector shutter's pivotal motion initially causes the receptacle shutter to pivot inwardly, it is understood that this action is dependent on the relative distances between each of the shutters and the extent to which one shutter is caused to move before the other, or is caused to move at a more rapid angular rate than the other shutter.

The relationship of the shutters to the joined connector and bulkhead elements will be best appreciated from the cross-sectional view of FIG. 6B. As will be seen, when the connector is fully inserted into the receptacle, the connector shutter 105 is accommodated in a slot 915 formed in the jack base, while the receptacle shutter 450 resides in the space between the upper wall of the bulkhead and the body of the inserted connector.

As best seen in FIG. 9B, the connector shutter slot 915, which accommodates the connector shutter 105 in the open position, is formed in the jack base. It will be recalled that the connector shutter swings open to project forwardly as the connector enters the receptacle. When the connector is fully inserted, the shutter resides at least partially within the slot 915.

It should be mentioned that the connector shutter, for example, need not be supported by a hinged mechanism in order to move rotatably between open and closed positions. For example, the shutter can be positionally located by pins laterally extending from the shutter sides and riding in curved slots at the sides of the connector body. In this case, the shutter is preferably resiliently biased to retract backwardly as it rotates to an open position. Accordingly, the length of the receptacle bulkhead or jack base can be shortened due the shortened dimension of the forwardly projecting open shutter.

Also, the jack base 305 may include a connection detection device, such as a spring-loaded Micro-switch (the detection device need not be a mechanical switch, it may be a Hall-Effect detector/activator, a magnetic switch, a optical switch, etc. . .). Referring to FIG. 9D, the front face of the jack base can be seen to include a pair of boxes 916 at the upper corners of the jack base provided to accommodate a small switch-engaging shaft (not shown). When a switch is provided, the shaft extends through the face of the jack base to project slightly into the connector-receiving space 918 (FIGS. 9B and 9C) where the end of the shaft is contacted by the flange 130 of the connector when fully inserted. The rear end of the shaft engages the actuating lever of the switch so that, when the connector is fully inserted into the receptacle jack base, the switch is closed. Conversely, withdrawing the connector from the jack base causes the switch to open. The Micro-switch, when provided is mounted to the jack base body at either side at the rear of the jack base body, as illustrated by the phantom lines in FIGS. 9A and 9D.

The Micro-switch, in turn, is operatively connected to a power source for the light emitting device (opto-electronic device) terminated by the receptacle 300. Inserting and removing the connector 100, thereby closes and opens the microswitch. Consequently, inserting the connector 100 energizes the power source to the light emitting device connected to the receptacle 300. On the other hand, removing the connector 100, disconnects the power source.

Yet another embodiment of the invention involves a similar connector/receptacle system implementing a modification of the shutters. In this embodiment the single shutters on each side of the assembly are replaced by two shutters rotatably supported at opposite sides (top and bottom) of the respective connector and receptacle. Each shutter covers half of the terminating faces of the connector and receptacle. In essence, each shutter is a split shutter in which the shutter halves move individually, but in a manner similar to that explained above in the case of unitary shutters.

Actuating the split shutters involves essentially the same mechanism as in the embodiment first described. In this case, however, each of the opposing connector and receptacle shutter halves will lie generally in planes at opposite sides of the opening rather than each shutter lying in a in only one plane and on opposite top and bottom sides of the assembly. As in the first embodiment, however, each half of the receptacle shutter is held in the open position by a top or bottom surface of the connector body. In the opening state, the leading edges of the connector shutter halves effectively serve as the actuating elements for pivoting the receptacle shutter halves rearwardly into the receptacle bulkhead. On the other hand, in this case the rear portion of the jack base contains a horizontal groove at both the top and the bottom to accommodate both of the connector shutter halves when in the open position.

The many features and advantages of the present invention are apparent from the detailed specification, and thus, it is intended by the appended claims to cover all such features and advantages of the invention which fall within the true spirit and scope of the invention. Furthermore, since the embodiments described above are exemplary, numerous modifications and variations will readily occur to those skilled in the art, and the invention should not be limited to the exact construction and operation illustrated and described herein.

We claim:

1. A fiber optic termination assembly, comprising:
a connector body;
a fiber optic ferrule-supporting structure within the connector body and presenting to the forward end of the connector a plurality of fiber optic terminating ferrules for a multi-fiber optical cable;
a receptacle body;
a fiber optic ferrule-supporting structure within the receptacle body and presenting to the forward end of the receptacle a plurality of fiber optic terminating ferrules for a multi-fiber optical cable, at least some of the supported ferrules of the receptacle and connector being axially aligned when the connector and receptacle are mated so as to establish a light-transmitting optical path therebetween;
a connector shutter supported by the connector body and rotatable between a closed position, wherein the shutter covers the connector ferrules, and an open position, wherein the shutter exposes the connector ferrules as to rotate between two positions which open and close the connector aperture; and
a receptacle shutter supported by the receptacle body and rotatable between a closed position, wherein the shutter covers the receptacle ferrules, and an open position, wherein the shutter exposes the receptacle,
the connector and receptacle shutters being operable to move from their closed positions to their open positions upon joining of the connector and the receptacle.

2. The fiber optic termination assembly of claim 1, wherein:
at least one of the connector and receptacle shutters is pivotally supported.

3. A fiber optic termination assembly, comprising:
a connector body;
a receptacle body, wherein the connector body and the receptacle body each define an aperture in an end of the connector body and receptacle body, respectively;
a connector shutter supported by the connector body;
a receptacle shutter supported by the receptacle body;
wherein the connector shutter and the receptacle shutter each are configured to rotate between a closed position covering the apertures and an open position exposing optical fiber terminations within the respective bodies as the connector body is joined with the receptacle body.

4. The fiber optic termination of claim 3, wherein:
the receptacle shutter is pivotably attached to the receptacle body.

5. The fiber optic termination of claim 4, wherein:
the receptacle shutter in the closed position pivots from the closed position toward the interior of the receptacle body into the open position.

6. The fiber optic termination of the claim 5, wherein:
the receptacle shutter is biased in the closed position when the receptacle body is not joined with the connector body.

7. The fiber optic termination assembly of claim 3, wherein:
the connector shutter is pivotably attached to the connector body.

8. The fiber optic termination assembly of claim 7, wherein:
the connector shutter in the closed position pivots from the closed position away from the interior of the connector body into the open position.

9. The fiber optic termination assembly of the claim 8, wherein:
the connector shutter is biased in the closed position when the connector body is not joined with the receptacle body.

10. The fiber optic termination assembly of the claim 9, wherein:
the connector shutter is formed with a camming surface along an edge.

11. The fiber optic termination assembly of the claim 3, wherein:
the aperture in the end of the receptacle body is contoured to correspond to a leading edge of the connector body.

12. The fiber optic termination assembly of the claim 11, wherein:
the receptacle body is formed to accept the connector body with the connector shutter biased in the open position.

13. The fiber optic termination assembly of the claim 12, wherein:
the receptacle body includes a connector shutter recess configured to accommodate the connector shutter biased in the open position.

14. The fiber optic termination assembly of the claim 13, wherein:
the receptacle body includes a camming surface formed on a bottom wall of the receptacle body.

15. The fiber optic termination assembly of the claim 14, wherein:
the receptacle body camming surface is configured to actuate the connector shutter between the closed position and the open position.

16. The fiber optic termination assembly of claim 3, further comprising:
a switch in the receptacle body operatively connected to an opto-electronic device.

17. A fiber optic connector comprising:
a connector body adopted to be received by a receptacle body;
a connector shutter supported by the connector body;
an aperture defined in an end of the connector body, wherein the connector shutter is normally disposed in a closed position covering the aperture, the exterior of the connector body being configured to actuate a receptacle shutter and establish a fiber-optic connection within a receptacle.

18. The fiber optic connector of claim 17, wherein:
the connector shutter is formed with a camming surface along an edge.

19. The fiber optic connector of claim 18, wherein:
the connector shutter is configured to pivotably rotate between the closed position and an open position exposing the interior of the connector body.

20. The fiber optic connector of claim 19, wherein:
the connector shutter in the closed position pivotably rotates from the closed position away from the interior of the connector body into the open position.

21. The fiber optic connector of claim 20, wherein:
the connector shutter pivotably rotates as the shutter camming surface contacts a receptacle camming surface.

22. The fiber optic connector of claim 21, wherein:
the connector body is formed with a leading edge contoured to correspond to an aperture in a receptacle body.

23. A fiber optic termination assembly, comprising:
a connector body;
a receptacle body, wherein the connector body and the receptacle body each define an aperture in an end of the connector body and receptacle body, respectively; and
a detector device within the receptacle body, wherein the detector device conditionally activates a power supply operatively connected to a opto-electronic device.

24. The fiber optic termination assembly in claim 23, wherein:
the detection device activates the power supply upon sensing a connection between the connector body and the receptacle body.

25. The fiber optic termination assembly in claim 23, wherein:
the detection device deactivates the power supply upon sensing a disconnection of the connector body and the receptacle body.
